(19) United States
(12) Patent Application Publication
(10) Pub. No.: US 2018/0335910 A1
(43) Pub. Date: Nov. 22, 2018

(54) DISPLAY METHOD AND TERMINAL

(71) Applicant: SMARTISAN DIGITAL CO., LTD., Beijing (CN)

(72) Inventors: Chi Fang, Beijing (CN); Song Liu, Beijing (CN)

(21) Appl. No.: 15/981,414

(22) Filed: May 16, 2018

(30) Foreign Application Priority Data
May 19, 2017 (CN) 201710358512.9

(51) Int. Cl. G06F 3/0484; G06F 3/0481

(52) U.S. Cl. CPC G06F 3/0484; G06F 3/0481

(57) ABSTRACT

A display method and a terminal are provided. With the display method and the terminal, a first application is displayed using a first application stack in a screen locked state. Since the first application stack may be displayed over a screen locked interface, that is, the first application stack may be displayed at the foremost position in the screen locked state, an interface of an application displayed in the second application stack can be displayed normally in the screen locked state. Therefore, the user may use or operate the first application in the screen locked state.

### CROSS REFERENCE TO RELATED APPLICATION

The present application claims priority to Chinese Patent Application No. 201710358512.9, titled “DISPLAY METHOD AND TERMINAL”, filed on May 19, 2017 with the State Intellectual Property Office of People's Republic of China, which is incorporated herein by reference in its entirety.

### FIELD

The present disclosure relates to the field of electronic information, and in particular to a display method and a terminal.

### BACKGROUND

The screen locking function is often used in terminals. With the screen locking function, a misoperation on a display interface of a terminal can be prevented in a screen locked state. However, in some scenarios, the user may need to operate an application frequently while preventing a mis-touch on another application. For example, in a case where the user is doing exercise, the user may wish to play music using the terminal without touching other applications on the terminal by mistake.

It can be seen that a problem to be solved urgently is how to make the terminal display an application in the screen locked state.

### SUMMARY

A method and a terminal are provided according to the present disclosure to solve the above problem.

In order to achieve the above object, the following technical solutions are provided according to the present disclosure.

A display method is provided, which includes:

acquiring an instruction message for instructing to display a first application in a screen locked state; and

displaying, after a terminal is switched to the screen locked state, the first application using a first application stack, where the first application stack is displayed over a screen locked interface.

In an embodiment, before the terminal is switched to the screen locked state, an interface of the first application is displayed using a second application stack.

The displaying the first application using the first application stack includes:

migrating the interface of the first application from the second application stack to the first application stack.

In an embodiment, before the terminal is switched to the screen locked state, an interface of the second application is displayed using the second application stack, the interface of the first application is displayed at top of the second application stack, a desktop stack is displayed under the second application stack, and the desktop stack is configured to display a desktop.

After the terminal is switched to the screen locked state, the method further includes:

migrating the second application stack to be displayed under the desktop stack.

In an embodiment, the method further includes:

migrating, after the terminal is switched from the screen locked state to an unlocked state, the interface of the first application from the first application stack to the top of the second application stack, and migrating, after the terminal is switched from the screen locked state to the unlocked state, the second application stack to be displayed over the desktop stack.

In an embodiment, before the terminal is switched to the screen locked state, the interface of the second application is displayed using the second application stack, the interface of the second application is displayed at the top of the second application stack, the desktop stack is displayed under the second application stack, and the desktop stack is configured to display a desktop.

After the terminal is switched from the screen locked state to an unlocked state, the method further includes:

migrating the interface of the first application from the first application stack to the second application stack, where the interface of the second application is displayed at the top of the second application stack.

In an embodiment, before the terminal is switched to the screen locked state, the interface of the second application is displayed using the second application stack, the second application stack is displayed under the desktop stack, and the desktop stack is configured to display a desktop.

After the terminal is switched from the screen locked state to an unlocked state, the method further includes:

migrating the interface of the first application from the first application stack to the second application stack, where the interface of the first application and the interface of the second application are returned to respective positions in the second application stack before the terminal is switched to the screen locked state.

A terminal is further provided, which includes: an acquiring module and a display module.

The acquiring module is configured to acquire an instruction message for instructing to display a first application in a screen locked state; and

the display module is configured to display, after the terminal is switched to the screen locked state, the first application using a first application stack, where the first application stack is displayed over a screen locked interface.

In an embodiment, the terminal has a second application stack. Before the terminal is switched to the screen locked state, the terminal displays an interface of the first application using the second application stack.

In order to display the first application using the first application stack, the display module is configured to migrate the interface of the first application from the second application stack to the first application stack.

In an embodiment, before the terminal is switched to the screen locked state, an interface of the second application is displayed using the second application stack, the interface of the first application is displayed at top of the second application stack, the terminal has a desktop stack configured to display a desktop, and the desktop stack is displayed under the second application stack.

The display module is further configured to migrate, after the terminal is switched to the screen locked state, the second application stack to be displayed under the desktop stack.

In an embodiment, the display module is further configured to:

migrate, after the terminal is switched from the screen locked state to an unlocked state, the interface of the first application from the first application stack to the top of the second application stack, and migrate, after the terminal is switched from the screen locked state to the unlocked state, the second application stack to be displayed over the desktop stack.

In an embodiment, before the terminal is switched to the screen locked state, an interface of the second application is displayed using the second application stack, the interface of the second application is displayed at top of the second application stack, the terminal has a desktop stack configured to display a desktop, and the desktop stack is displayed under the second application stack.

The display module is further configured to migrate, after the terminal is switched from the screen locked state to an unlocked state, the interface of the first application from the first application stack to the second application stack, where the interface of the second application is displayed at the top of the second application stack.

In an embodiment, before the terminal is switched to the screen locked state, an interface of the second application is displayed using the second application stack, the terminal has a desktop stack configured to display a desktop, and the second application stack is displayed under the desktop stack.

The display module is further configured to migrate, after the terminal is switched from the screen locked state to an unlocked state, the interface of the first application from the first application stack to the second application stack, where the interface of the first application and the interface of the second application are returned to respective positions in the second application stack before the terminal is switched to the screen locked state.

With the display method and the terminal provided according to the present disclosure, a first application is displayed using a first application stack in a screen locked state. Since the first application stack can be displayed over the screen locked interface, that is, the first application stack can be displayed at the foremost position in the screen locked state, an interface of an application displayed in the second application stack can be displayed normally in the screen locked state. Therefore, the user can use or operate the first application in the screen locked state.

### BRIEF DESCRIPTION OF THE DRAWINGS

In order to more clearly describe the technical solution in the embodiments of the present disclosure or the technical solution in the conventional technology, drawings to be used in the embodiments of the present disclosure or in the conventional technology are briefly described hereinafter. It is apparent that the drawings described below show merely the embodiments of the present disclosure, and those skilled in the art may obtain other drawings according to the provided drawings without any creative effort.

FIG. 1 is a schematic diagram of a window display mechanism for an existing terminal;

FIG. 2 is a flowchart of a display method according to an embodiment of the present disclosure;

FIG. 3 is a flowchart of a display method according to another embodiment of the present disclosure;

FIG. 4 is a flowchart of a display method according to another embodiment of the present disclosure;

FIG. 5 is a flowchart of a display method according to another embodiment of the present disclosure; and

FIG. 6 is a schematic structural diagram of a terminal according to an embodiment of the present disclosure.

### DETAILED DESCRIPTION OF EMBODIMENTS

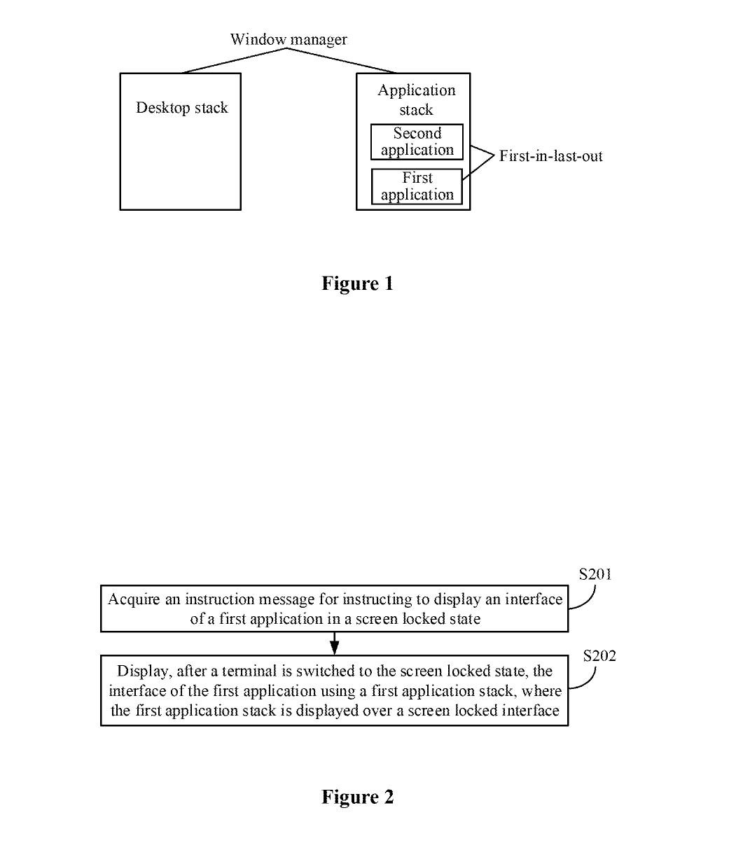

FIG. 1 is a schematic diagram of a window display mechanism for an existing terminal. In an Android system, two window managers are arranged to respectively display a desktop and an application. The window manager adopts a data stack running mechanism of first-in-last-out. Therefore, the window manager for displaying the desktop is referred to as a desktop stack. The window manager for displaying the application is referred to as an application stack.

For example, a started application is displayed in an application stack. Since the application stack adopts a running mechanism of first-in-last-out, an interface of an application that is started first is displayed under an interface of an application that is started later.

In the conventional technology, after the terminal is switched to a screen locked state, a screen locked interface is displayed over the desktop stack and the application stack. That is, the screen locked interface is displayed at the foremost position, the desktop stack and the application stack are concealed by the screen locked interface.

In the embodiments of the present disclosure, an application stack displayed over the screen locked interface in a screen locked state is added in the terminal based on the window displaying mechanism shown in FIG. 1 (in order to distinguish, the added application stack is referred to as a first application stack, and an original application stack is referred to as a second application stack), to achieve an object of displaying an application in the screen locked state.

The technical solutions of the embodiments of the present disclosure are described clearly and completely with reference to the accompanying drawings in the embodiments of the present disclosure hereinafter. It is apparent that the described embodiments are merely some rather than all of the embodiments of the present disclosure. All other embodiments obtained by those skilled in the art based on the embodiments of the present disclosure without any creative effort shall fall within the protection scope of the present disclosure.

FIG. 2 is flowchart of a display method according to an embodiment of the present disclosure. The display method is applied to a terminal having a desktop stack, a first application stack and a second application stack. The method in FIG. 2 includes the following steps S201 and S202.

In step S201, an instruction message is acquired, where the instruction message is used to instruct to display a first application in a screen locked state.

In an example, a type of the instruction message may be set in advance, and the instruction message may be generated by triggering from an operation performed on the first application. For example, a user sets a “pushpin” identifier on an icon of the first application to trigger generation of the instruction message.

In step S202, after the terminal is switched to the screen locked state, the first application is displayed using the first application stack. The first application stack is displayed over the screen locked interface.

In the embodiment, a form that the first application stack is displayed over the screen locked interface is not specifically limited. For example, the first application stack is displayed over the screen locked interface, with a size of the first application stack being less than or equal to that of the screen locked interface. The first application stack may be translucent to reveal the screen locked interface concealed by the first application stack.

As described above, the first application stack has an attribute of being displayed over the screen locked interface. Therefore, the first application stack differs from the desktop stack and the second application stack in that the first application stack can be displayed over the screen locked interface, that is, the first application stack can be displayed at the foremost position in the screen locked state. Therefore, an interface of an application displayed in the second application stack can be displayed normally in the screen locked state. Therefore, the user can use or operate the first application in the screen locked state.

For display states of the first application stack, the second application stack and the desktop stack before the screen is locked, display states of the first application stack, the second application stack and the desktop stack after the screen is locked are described hereinafter.

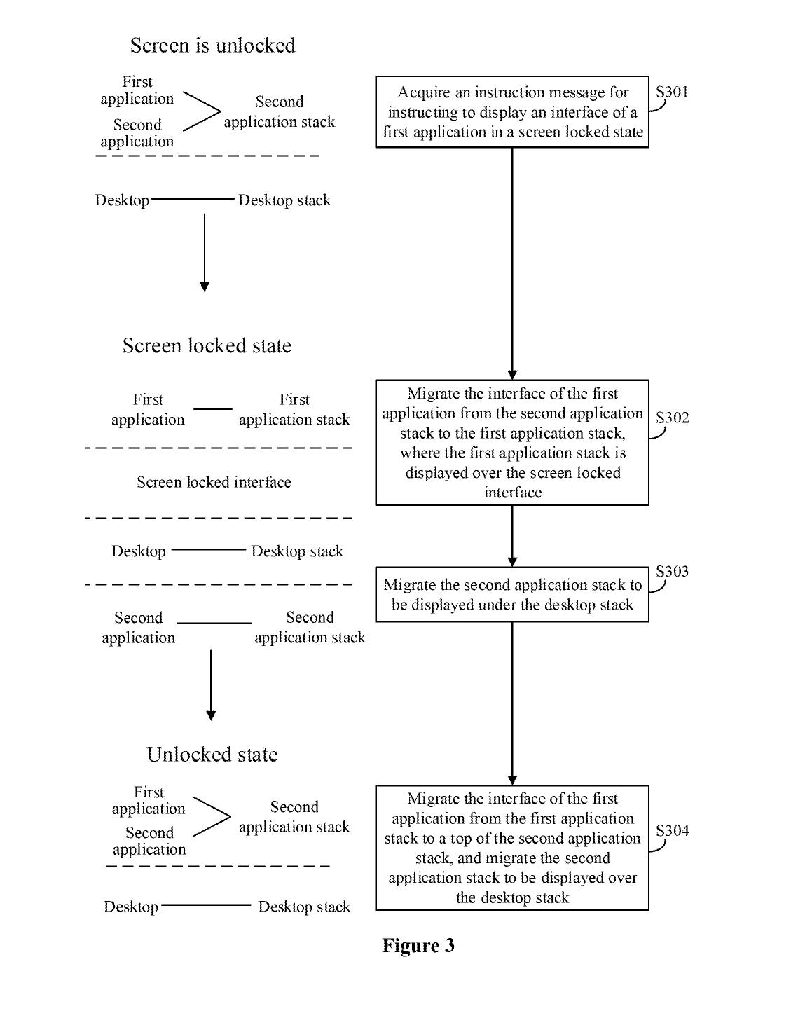

In FIG. 3, before the screen is locked, an interface of the first application and an interface of the second application are displayed using the second application stack, and the interface of the first application is displayed at the top of the second application stack. The interface of the second application is displayed under the interface of the first application in the second application stack. The desktop is in an un-displayed state, that is, the desktop stack is displayed under the second application stack. For example, an album application (the second application) is started in the desktop, then a Wechat application (the first application) is started through a sharing function of the album application.

In this case, a display method according to another embodiment includes the following steps S301 to S304.

In step S301, an instruction message is acquired in a case where the terminal is in an unlocked state. The instruction message is used to instruct to display an interface of a first application in a screen locked state.

For example, the user selects a “pushpin” function from a sidebar in the desktop and clicks an icon of the first application to add a “pushpin” on the icon of the first application.

In step S302, after the terminal is switched to the screen locked state, the interface of the first application is migrated from the second application stack to the first application stack. The first application stack is displayed over the screen locked interface.

In step S303, the second application stack is migrated to be displayed under the desktop stack.

In step S304, after the terminal is switched from the screen locked state to an unlocked state, the interface of the first application is migrated from the first application stack to the top of the second application stack, and the second application stack is migrated to be displayed over the desktop stack.

Following the above example, in the unlocked state, an album application (the second application) is started in the desktop, then a Wechat application (the first application) is started through the sharing function of the album application, and the Wechat application is pined with the “pushpin”. After the screen is locked, an interface of the Wechat application is displayed over the screen locked interface, the desktop is displayed under the screen locked interface, and an interface of the album application is displayed under the desktop. That is, if the screen locked interface is transparent, it can be seen that the desktop rather than the interface of the album application is displayed under the screen locked interface. After the screen is unlocked, the interface of the Wechat application is displayed at the foremost position, and the interface of the album application is displayed over the desktop.

As can be seen from FIG. 3, the first application is run before the screen is locked. After the “pushpin” function is set for the first application, the interface of the first application may be displayed over the screen locked interface. Moreover, in the screen locked state, the second application stack is migrated to be displayed under the desktop stack to ensure that the interface of the second application that is not pinned by the “pushpin” is not displayed even if the screen locked interface is transparent. After the screen is unlocked, the interface of the first application is displayed again over the desktop, and the first application and the second application are returned to display states before the screen is locked.

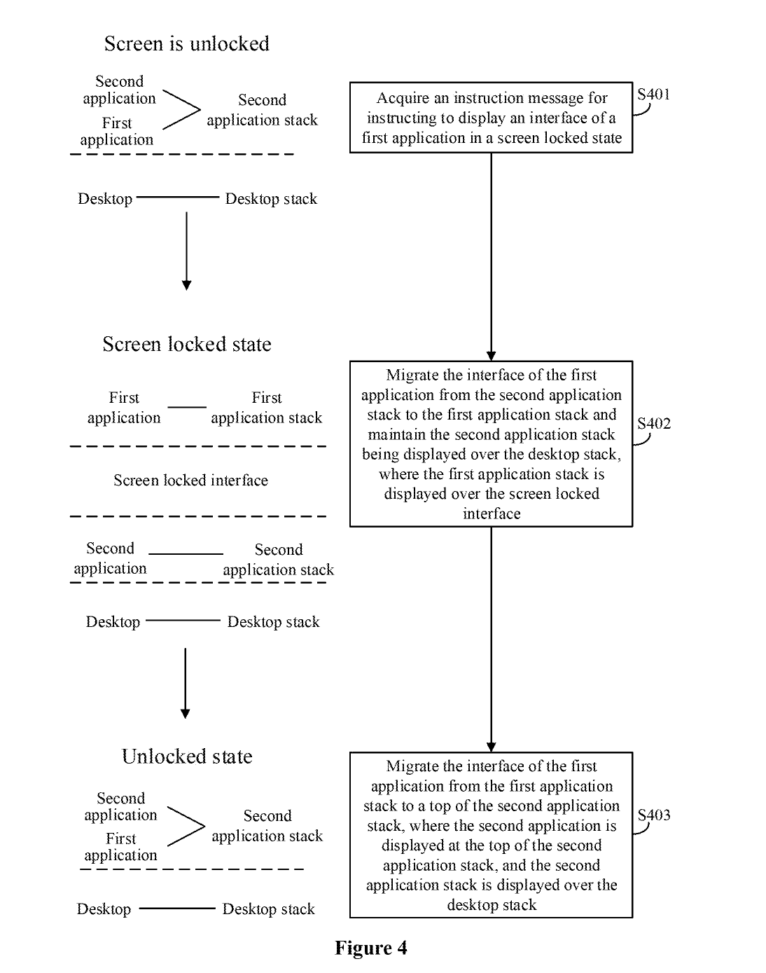

FIG. 4 differs from FIG. 3 in that before the screen is locked, the interface of the first application and the interface of the second application are displayed using the second application stack, and the interface of the second application is displayed at the top of the second application stack. The interface of the first application is displayed under the interface of the second application in the second application stack. For example, the Wechat application (the first application) is started in the desktop, then the album application (the second application) is started through a chat adding picture button of the Wechat application.

In this case, a display method according to another embodiment includes the following steps S401 to S403.

In step S401, an instruction message is acquired in a case where the terminal is in an unlocked state. The instruction message is used to instruct to display an interface of a first application in a screen locked state.

Following the above example, the Wechat application (the first application) is started in the desktop, then the Wechat application is pinned by the “pushpin”. The album application (the second application) is started through the chat adding picture button of the Wechat application.

It should be noted that, in the embodiments of the present disclosure, the time of receiving the instruction message (pinned by the “pushpin”) is not limited, and the instruction message may be received during a process of another operation. For example, the Wechat application is pinned by the “pushpin” during a process of adding a picture using the Wechat application. The instruction message may also be received before or after performing another operation, or the instruction message may be received independent of another operation. For example, the Wechat application is pinned by the “pushpin” before the Wechat application is started, then the Wechat application is used to add a picture.

In step S402, after the terminal is switched to the screen locked state, the interface of the first application is migrated from the second application stack to the first application stack. The first application stack is displayed over the screen locked interface. In addition, the second application stack is maintained being displayed over the desktop stack.

In step S403, after the terminal is switched from the screen locked state to the unlocked state, the interface of the first application is migrated from the first application stack to the second application stack. The second application is displayed at the top of the second application stack, and the second application stack is displayed over the desktop stack.

Following the above example, in the unlocked state, the Wechat application (the first application) is started in the desktop, then the Wechat application is pinned by the “pushpin”. The album application (the second application) is started through the chat adding picture button of the Wechat application. After the screen is locked, the interface of the Wechat application is displayed over the screen locked interface, and the interface of the album application is displayed under the screen locked interface and over the desktop. That is, if the screen locked interface is transparent, it can be seen that the interface of the album application is displayed under the screen locked interface. After the screen is unlocked, the interface of the album application is displayed at the foremost position, and the interface of the Wechat application is displayed over the desktop.

As can be seen from FIG. 4, an interface of an application displayed at the top of the second application stack, before the screen is locked, is displayed over the desktop after the screen is locked.

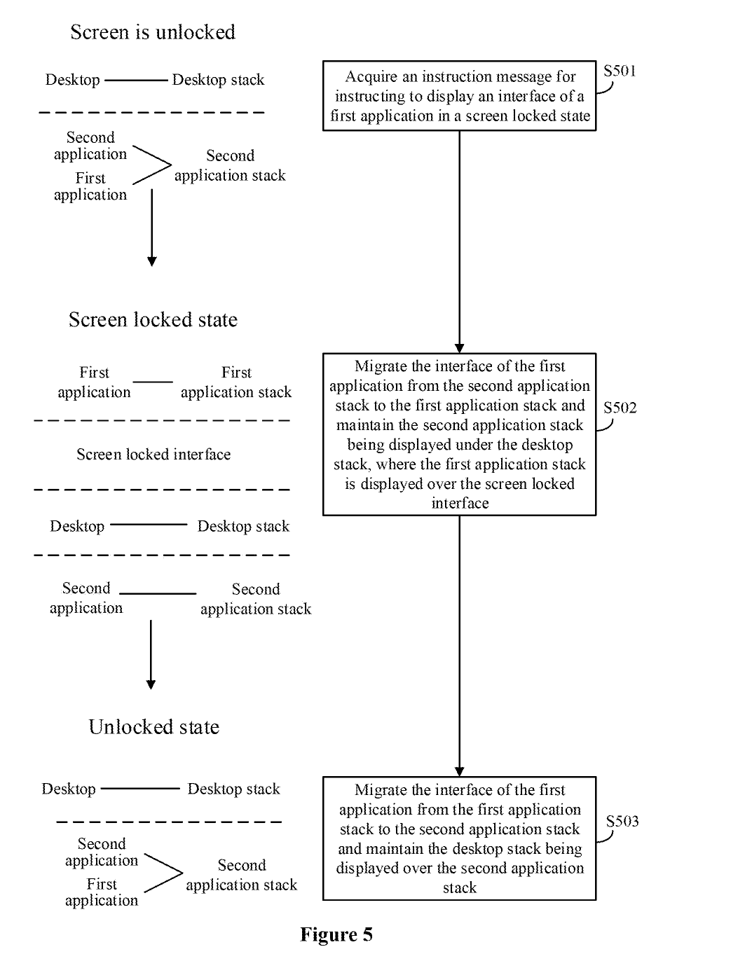

FIG. 5 differs from FIGS. 3, 4 in that the desktop is in a displayed state before the screen is locked. The interface of the first application and the interface of the second application are displayed using the second application stack, and the second application stack is displayed under the desktop stack. For example, the album, application is started in the desktop, the Wechat application is started through an analysis function of the album application, then the Home button is pressed to display the desktop.

In this case, a display method according to another embodiment includes the following steps S501 to S503.

In step S501, an instruction message is acquired in a case where the terminal is in an unlocked state. The instruction message is used to instruct to display an interface of a first application in a screen locked state.

For example, the album application is started in the desktop, and the Wechat application is started through the sharing function of the album application. The Wechat application is pinned by the “pushpin”, then the Home button is pressed to display the desktop.

In step S502, after the terminal is switched to the screen locked state, the interface of the first application is migrated from the second application stack to the first application stack. The first application stack is displayed over the screen locked interface. In addition, the second application stack is maintained being displayed under the desktop stack. The second application stack may continually display the interface of the second application, or suspend displaying the interface of the second application to save power.

In step S503, after the terminal is switched from the screen locked state to the unlocked state, the interface of the first application is migrated from the first application stack to the second application stack, and the desktop stack is maintained being displayed over the second application stack.

The interface of the first application and the interface of the second application are returned to respective positions in the second application stack before the screen is locked.

Following the above example, the album application is started in the desktop, the Wechat application is started through the sharing function of the album application and is pinned by the “pushpin”, then the Home button is pressed to display the desktop. After the screen is locked, the interface of the Wechat application is displayed over the screen locked interface, the desktop is displayed under the screen locked interface, and the second application stack is displayed under the desktop.

As can be seen from the processes shown in FIG. 2 to FIG. 5, with the display method according to the embodiments of the present disclosure, an application stack capable of being displayed over the screen locked interface is added on the basis of a display mechanism of the existing Android system based on the application stack and the desktop stack. In addition, an interface of an application is displayed using the added application stack in a screen locked state. Therefore, the object of displaying an application in the screen locked state is achieved. Furthermore, the above object can be achieved only by the added application stack. Therefore, compatibility with the existing terminal system is high, thereby facilitating implementation through software and hardware.

In an embodiment, in the unlocked state, if the instruction message is received in a case where the first application is not nm, that is, the first application is pinned by the “pushpin” before the first application is run, only an icon of the first application may be displayed after the terminal is switched to the screen locked interface. That is, the icon of the first application is displayed in the first application stack, while the first application is not run. A user may click the icon of the first application in the screen locked state to trigger the running of the first application. The interface of the first application is displayed in the second application stack in a case of receiving information that the user clicks the icon of the first application. That is, the “displaying the first application using the first application stack” shown in FIG. 2 includes “displaying the icon of the first application using the first in application stack” and/or “displaying the interface of the first application using the first application stack”.

It should be noted that a difference between the display method provided according to the embodiments of the present disclosure and the conventional technology of displaying a screen locked interface of a music player in a screen locked state is described as follows.

In the conventional technology, a screen locked interface of a music player is based on an interface design set by the Android system for the screen locking operation. That is, according to the interface protocol, the screen locked interface of the music player is designed to be displayed in the screen locked state only by rewriting codes. If it is required to display an interface of another application in the screen locked state, it is also required to rewrite a program according to the interface protocol.

In the embodiments of the present disclosure, the object of displaying an application in the screen locked state is achieved by adding an application stack displayed over the screen locked interface, which is implemented easier as compared with the above conventional technology.

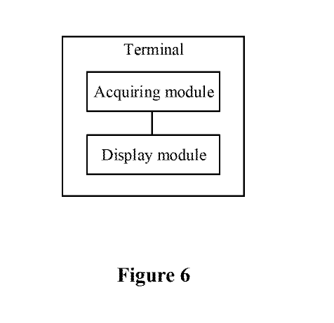

FIG. 6 shows a terminal according to an embodiment of the present disclosure, which includes an acquiring module and a display module.

The acquiring module is configured to acquire an instruction message for instructing to display the first application in a screen locked state. The display module is configured to display the first application using the first application stack after the terminal is switched to the screen locked state. The first application stack is displayed over the screen locked interface.

The terminal further includes a second application stack and a desktop stack. The display module achieves the object of displaying the application over the screen locked interface by controlling display functions of the first application stack, the second application stack and the desktop stack, by executing steps other than those performed by the acquiring module in the processes shown in FIG. 2 to FIG. 5.

Various embodiments in this specification are described in a progressive manner, each embodiment focuses on the difference from other embodiments. The same or similar parts among various embodiments may be referred to each other.

The above description of the disclosed embodiments enables those skilled in the art to implement or use the present disclosure. Various modifications to these embodiments are readily apparent to those skilled in the art. The general principles defined herein may be applied to other embodiments without departing from the spirit or scope of the disclosure. Therefore, the present disclosure is not limited to the embodiments shown herein, but should conform to the widest scope consistent with the principles and novel features disclosed herein.

1. A display method, comprising:
acquiring an instruction message for instructing to display a first application in a screen locked state; and
displaying, after a terminal is switched to the screen locked state, the first application using a first application stack, wherein the first application stack is displayed over a screen locked interface.

2. The method according to claim 1, wherein before the terminal is switched to the screen locked state, an interface of the first application is displayed using a second application stack; and wherein
the displaying the first application using the first application stack comprises:
migrating the interface of the first application from the second application stack to the first application stack.

3. The method according to claim 2, wherein before the terminal is switched to the screen locked state, an interface of the second application is displayed using the second application stack, the interface of the first application is displayed at top of the second application stack, a desktop stack is displayed under the second application stack, and the desktop stack is configured to display a desktop; and wherein
after the terminal is switched to the screen locked state, the method further comprises:
migrating the second application stack to be displayed under the desktop stack.

4. The method according to claim 3, further comprising:
migrating, after the terminal is switched from the screen locked state to an unlocked state, the interface of the first application from the first application stack to the top of the second application stack, and migrating, after the terminal is switched from the screen locked state to the unlocked state, the second application stack to be displayed over the desktop stack.

5. The method according to claim 2, wherein before the terminal is switched to the screen locked state, the interface of the second application is displayed using the second application stack, the interface of the second application is displayed at the top of the second application stack, the desktop stack is displayed under the second application stack, and the desktop stack is configured to display a desktop; and wherein
after the terminal is switched from the screen locked state to an unlocked state, the method further comprises:
migrating the interface of the first application from the first application stack to the second application stack, wherein the interface of the second application is displayed at the top of the second application stack.

6. The method according to claim 2, wherein before the terminal is switched to the screen locked state, the interface of the second application is displayed using the second application stack, the second application stack is displayed under the desktop stack, and the desktop stack is configured to display a desktop; and wherein
after the terminal is switched from the screen locked state to an unlocked state, the method further comprises:
migrating the interface of the first application from the first application stack to the second application stack, wherein the interface of the first application and the interface of the second application are returned to respective positions in the second application stack before the terminal is switched to the screen locked state.

7. A terminal, comprising:
an acquiring module configured to acquire an instruction message for instructing to display a first application in a screen locked state; and
a display module configured to display, after the terminal is switched to the screen locked state, the first application using a first application stack, wherein the first application stack is displayed over a screen locked interface.

8. The terminal according to claim 7, wherein the terminal has a second application stack, and before the terminal is switched to the screen locked state, the terminal displays an interface of the first application using the second application stack; and
in order to display the first application using the first application stack, the display module is configured to migrate the interface of the first application from the second application stack to the first application stack.

9. The terminal according to claim 8, wherein before the terminal is switched to the screen locked state, an interface of the second application is displayed using the second application stack, the interface of the first application is displayed at top of the second application stack, the terminal has a desktop stack configured to display a desktop, and the desktop stack is displayed under the second application stack; and
the display module is further configured to migrate, after the terminal is switched to the screen locked state, the second application stack to be displayed under the desktop stack.

10. The terminal according to claim 9, wherein the display module is further configured to:
migrate, after the terminal is switched from the screen locked state to an unlocked state, the interface of the first application from the first application stack to the top of the second application stack, and migrate, after the terminal is switched from the screen locked state to the unlocked state, the second application stack to be displayed over the desktop stack.

11. The terminal according to claim 8, wherein before the terminal is switched to the screen locked state, an interface of the second application is displayed using the second application stack, the interface of the second application is displayed at top of the second application stack, the terminal has a desktop stack configured to display a desktop, and the desktop stack is displayed under the second application stack; and
the display module is further configured to migrate, after the terminal is switched from the screen locked state to an unlocked state, the interface of the first application from the first application stack to the second application stack, wherein the interface of the second application is displayed at the top of the second application stack.

12. The terminal according to claim 8, wherein before the terminal is switched to the screen locked state, an interface of the second application is displayed using the second application stack, the terminal has a desktop stack configured to display a desktop, and the second application stack is displayed under the desktop stack; and
the display module is further configured to migrate, after the terminal is switched from the screen locked state to an unlocked state, the interface of the first application from the first application stack to the second application stack, wherein the interface of the first application and the interface of the second application are returned to respective positions in the second application stack before the terminal is switched to the screen locked state.
